(19) United States
(12) Patent Application Publication
(10) Pub. No.: US 2010/0157280 A1
(43) Pub. Date: Jun. 24, 2010

(54) METHOD AND SYSTEM FOR ALIGNING A LINE SCAN CAMERA WITH A LIDAR SCANNER FOR REAL TIME DATA FUSION IN THREE DIMENSIONS

(75) Inventors: Kresimir Kusevic, Ottawa (CA); Paul Mrstik, Ottawa (CA); Craig Len Glennie, Spring, TX (US)

Correspondence Address: AMBERCORE SOFTWARE INC., 1 ANTARES DRIVE, SUITE 140, OTTAWA, ON, K2E-8C4, CA

(73) Assignee: Ambercore Software Inc., Ottawa (CA)

(21) Appl. No.: 12/642,144

(22) Filed: Dec. 18, 2009

Related U.S. Application Data
(60) Provisional application No. 61/139,015, filed on Dec. 19, 2008.

(51) Int. Cl. G01C 3/08

(52) U.S. Cl. 356/4.01

(57) ABSTRACT

An apparatus and method for aligning a line scan camera with a Light Detection and Ranging (LiDAR) scanner for real-time data fusion in three dimensions is provided. Imaging data is captured at a computer processor simultaneously from the line scan camera and the laser scanner from target object providing scanning targets defined in an imaging plane perpendicular to focal axes of the line scan camera and the LiDAR scanner. X-axis and Y-axis pixel locations of a centroid of each of the targets from captured imaging data is extracted. LiDAR return intensity versus scan angle is determined and scan angle locations of intensity peaks which correspond to individual targets is determined. Two axis parallax correction parameters are determined by applying a least squares. The correction parameters are provided to post processing software to correct for alignment differences between the imaging camera and LiDAR scanner for real-time colorization for acquired LiDAR data.

### CROSS REFERENCE TO RELATED APPLICATIONS

This application claims priority from U.S. Provisional Application No. 61/139,015 filed on Dec. 19, 2008, the contents of which is hereby incorporated by reference.

### TECHNICAL FIELD

The present disclosure relates to the field of surveying and mapping. In particular, to a method for aligning a line scan camera with a LiDAR scanner for real time data fusion in three dimensions.

### BACKGROUND

LiDAR (Light Detection and Ranging) is used to generate a coordinate point cloud consisting of three dimensional coordinates. Usually each point in the point cloud includes the attribute of intensity, which is a measure of the level of reflectance at the coordinate point. Intensity is useful both when extracting information from the point cloud and for visualizing the cloud.

Photographic image information is another attribute that, like intensity, enhances the value of coordinate point data in the point cloud. In attaching an image attribute such as grey scale or color to a LiDAR coordinate point there are several challenges including the elimination of shadowing and occlusion errors when a frame camera is used for acquiring the image component.

Another challenge is the accurate bore sighting and calibration of the imaging device with the LiDAR. A third challenge is the processing overhead encountered when traditional conventional photogrammetric calculations are used to collocate the image data with the LiDAR coordinate points.

One known approach for attaching image information to coordinate points in a LiDAR point cloud is to co-locate a digital frame camera with the LiDAR sensor and use conventional methods such as the co-linearity equations to associate each LiDAR point with a pixel in the digital frame. The problem with this approach is that while the imagery is collected as a frame at some point in time, the LiDAR data is collected as a moving line scan covering the same area over a different period of time. The result is that the pixels in the image data may not be attached to the LiDAR point data with any great degree of accuracy.

Another known approach to attaching image information to coordinate points in a LiDAR point cloud is to use a line scan camera that mimics the LiDAR scan. The problem with this approach is that it is very difficult to align the line scan camera and the LiDAR sensor so that their respective scan lines are simultaneously scanning along the same line and observing the same geometry. Accordingly, methods and systems that enable aligning a line scan camera with a LiDAR scanner for real time data fusion in three dimensions remains highly desirable.

### SUMMARY

In accordance with the present disclosure there is provided a method of aligning a line scan camera with a Light Detection and Ranging (LiDAR) scanner for real-time data fusion in three dimensions. The line scan camera and LiDAR scanner coupled to a computer processor for processing received data. The method comprises a) capturing imaging data at the computer processor simultaneously from the line scan camera and the laser scanner from target object providing a plurality of scanning targets defined in an imaging plane perpendicular to focal axes of the line scan camera and the LiDAR scanner, wherein the plurality of scanning targets spaced horizontally along the imaging plane; b) extracting x-axis and y-axis pixel locations of a centroid of each of the plurality of targets from captured imaging data; c) determining LiDAR return intensity versus scan angle; d) extracting scan angle locations of intensity peaks which correspond to individual targets from the plurality of targets; and e) determining two axis parallax correction parameters, at a first nominal distance from the target object, by applying a least squares adjustment to determine row and column pixel locations of laser return versus scan angle wherein the determined correction parameters are provided to post processing software to correct for alignment differences between the imaging camera and LiDAR scanner for real-time colorization for acquired LiDAR data.

In accordance with the present disclosure there is also provided a system for providing real time data fusion in three dimensions of Light Detection and Ranging (LiDAR) data. The system comprising a Light Detection and Ranging (LiDAR) scanner. A line scan camera providing a region of interest (ROI) extending horizontally across the imager of the line scan camera, the line scan camera and the LiDAR scanner aligned to be close to co-registered at given target object distance defined in an imaging plane perpendicular to focal axes of the line scan camera and the LiDAR scanner, the target object providing a plurality of scanning targets spaced horizontally along the imaging plane. A computer processor coupled to the LiDAR scanner and the line scan camera for receiving and processing data. A memory coupled to the computer processor, the memory providing instructions for execution by the computer processor. The instructions comprising capturing imaging data simultaneously from line scan camera and laser scanner from the plurality of targets at the computer processor. Extracting x and y pixel locations of a centroid of each of the plurality of targets from captured imaging data. Determining LiDAR return intensity versus scan angle. Extracting scan angle locations of intensity peaks which correspond to individual targets from the plurality of targets. Determining correction parameters by applying a least squares adjustment to determine row and column (pixel location) of laser return versus scan angle and wherein the determined correction parameters are provided to a post processing software to correct for alignment differences between the imaging camera and LiDAR scanner for real-time colorization for acquired LiDAR data.

### BRIEF DESCRIPTION OF THE DRAWINGS

Further features and advantages of the present disclosure will become apparent from the following detailed description, taken in combination with the appended drawings, in which:

FIG. 1 shows a schematic representation of a system for aligning a line scan camera with a LiDAR scanner for real time data fusion in three dimensions;

FIG. 2 shows a schematic representation of a side view showing y-axis offset between the line scan camera and the LiDAR scanner;

FIG. 3 shows a schematic representation of a 360° LiDAR scanner configuration using multiple line scan cameras;

FIG. 4 shows a geometric representation of aligning a line scan camera with a LiDAR scanner;

FIG. 5 shows a method of determining correction parameters; and

FIG. 6 shows representation of a LiDAR return intensity versus angle plot.

It will be noted that throughout the appended drawings, like features are identified by like reference numerals.

### DETAILED DESCRIPTION

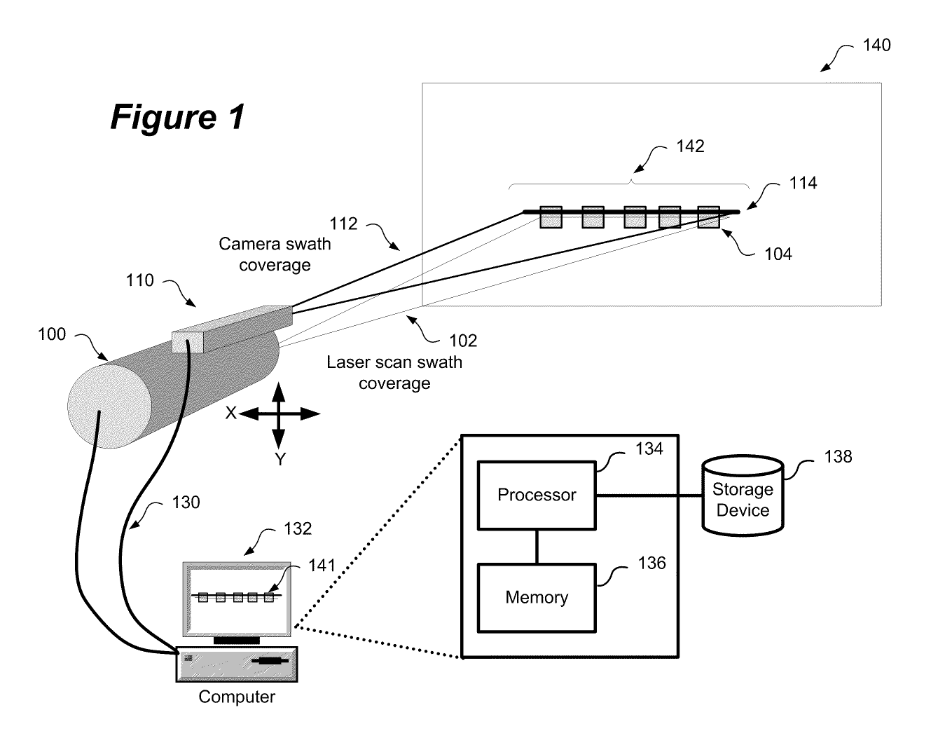

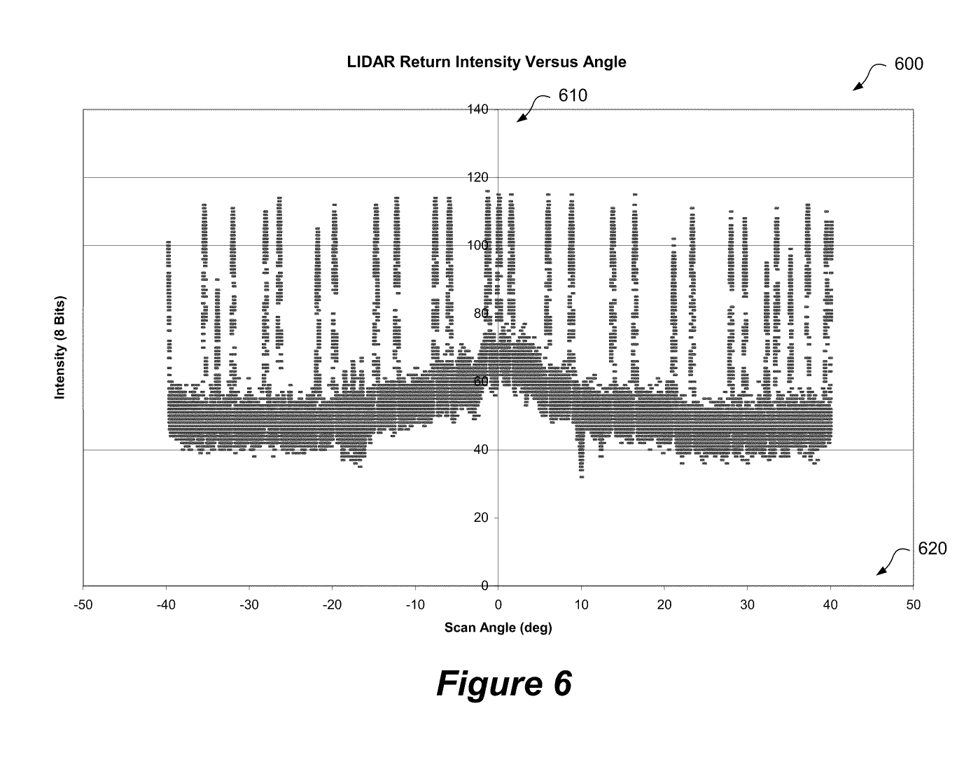

Embodiments are described below, by way of example only, with reference to FIGS. 1-6.

A method and system for aligning a line scan camera with a LiDAR scanner for real time data fusion in three dimensions is provided. This approach is also relevant for using an array of line scan cameras for fusion with one or more laser scanners. In order to correct for distortion between the line scan camera and LiDAR scanner correction parameters must be accurately applied to corrected data. The determination of these parameters must be performed during a calibration process to characterize the error generated by the mounting of the line scan camera and the LiDAR scanner.

FIG. 1 shows a schematic representation of a system for aligning a line scan camera with a LiDAR scanner for real time data fusion in 3-dimensions. In a LiDAR scanning system that enables the 3-D fusion of imagery the mounting of a line scan camera 110, with the LiDAR scanner 100 is critical in order to ensure accurate mapping of data collected by each device. The LiDAR point cloud must be accurately mapped to RGB information collected by the line scan camera imaging system. As the two devices cannot occupy the same physical space the respective focal points from an imaged object will not be precise, in one if not all three axes. The change in distance of the focal points between the line scan camera and the LiDAR scanner results in parallax distortion. In order to correct for this distortion calibration can be preformed to determine correction parameters that can be utilized to enable fusing of the line scan camera data and the LiDAR point cloud data.

In a LiDAR system, the line scan camera 110 and LiDAR scanner scan a plane perpendicular to the axis of the each device. In order to create correction parameters a vertical target surface 140 is utilized providing multiple reflective scanning targets 142 arranged along a horizontal axis. The scanning targets are space equidistant to each other along the target surface 140. The LiDAR scan 102 and line scan camera field of view data is captured by the respective devices. The line scan camera 110 is configured to provide a small horizontal region of interest, typically near the center of the imaging sensor. The height of the region of interest is selected as a portion of the overall possible imaging frame with sufficient height to capture a scanning range consistent with the LiDAR scanner and account for alignment differences. The use of a narrow region of interest provides a higher scans per second to be performed to match collect sufficient data to facilitate fusion of LiDAR and RGB data.

The data is provided to a computing device 132 providing a visual display of the targets 141. When coarse alignment has been performed and LiDAR scan line and line scan camera ROI relatively coincide parameter correction can be performed. The computing device 132 provides a processor 134 and memory 136 for executing instructions for determining calibration parameters. The computing device 132 can also be coupled to storage device 138 for storing instructions to perform the calibration functions and storing the determine calibration parameters. The stored instructions are executed by the processor 134.

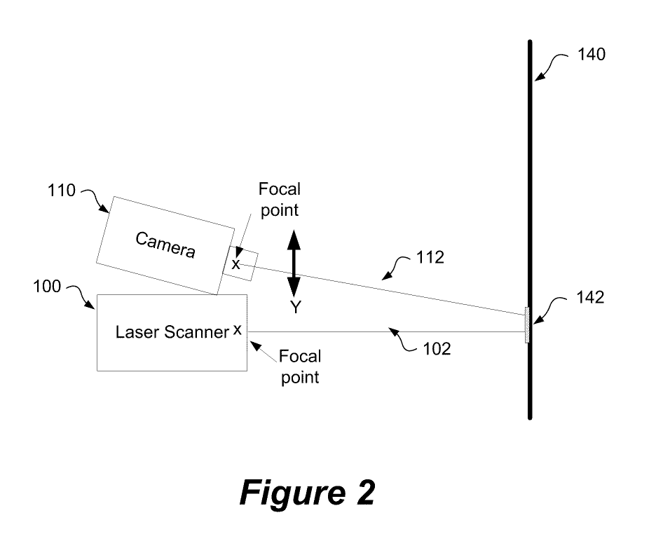

FIG. 2 shows a schematic representation of a side view showing y-axis offset between the line scan camera and the LiDAR scanner. In this example the camera 110 is vertically offset (y-axis) from the scanner 100 relative to the target surface 140. The focal point for each device is offset relative to each other providing distortion. It should be understood that although only a vertical offset is shown, the same principle applies to x-axis and z-axis. The laser scan plane is defined by the center of the pulse-reflecting rotating mirror and the scanned points in a single scan line. The line scan camera's scanning plane is defined by the points scanned in the object space and the camera's perspective center. To rectify the system both planes must be made to coincide. This is done by rotating the camera around its three body axis and adjusting the z linear offset of the mounting bracket while scanning the flat wall with some easily identifiable targets set up along a straight line.

The mounting of the camera, the heading angle is adjusted by rotating the camera about the Z-axis so that the entire region of interest of the camera's scanning field of view will cover the laser field of view. This can be verified by sighting the target points on the wall with both sensors simultaneously, first from a minimum scanning distance and then from an optimum scanning distance from the sensors. Once the heading angle has been adjusted, the roll of the camera is adjusted by rotating the camera around its Y-axis such that both camera and laser scans are parallel when the sensor is located at an optimum scanning distance from the target wall. The roll and pitch can be iteratively adjusted until the targets sighted by the laser appear in the camera scan, thus satisfying the parallelity condition. The pitch and z-axis offset are adjusted iteratively until the camera and laser scanning planes are coplanar.

Although the laser and camera systems are aligned so that both scanning planes are co-planar, there will be x-parallax remaining due to the horizontal linear offset between the camera perspective center and the laser center. This parallax results in a change in the correspondence of line scan camera pixels with laser points in a scan line with respect to the distance to a target.

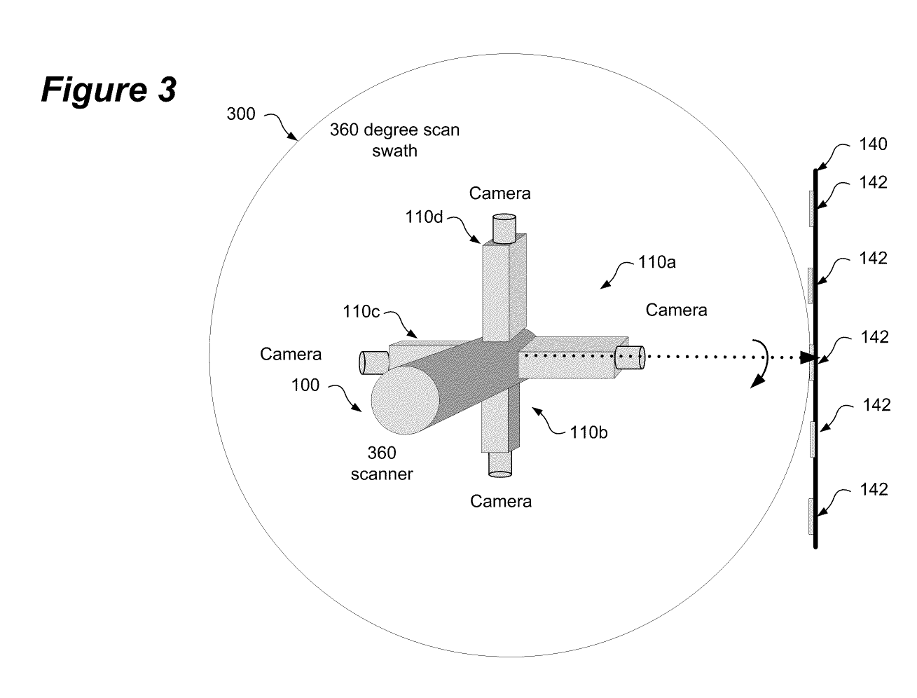

FIG. 3 shows a schematic representation of a 360° LiDAR scanner configuration using multiple line scan cameras. In this configuration the LiDAR scanner 100 is capable of 360° of scanning. This configuration requires multiple cameras 110a-110d to be utilized to enable coverage of the entire field of view of the LiDAR scanner. In the representation four cameras are shown, however the number may be increased or decreased based upon the relative field of view of each camera. Each camera can be individually calibrated to enable accurate fusing of data relative toe the scanning swath 300 of the LiDAR scanner. For each camera a target surface 140 is utilized in a plan perpendicular to the axis of the camera. Individual correction parameters are generated for each camera and applied to the collected data when imagery is fused with collected LiDAR data.

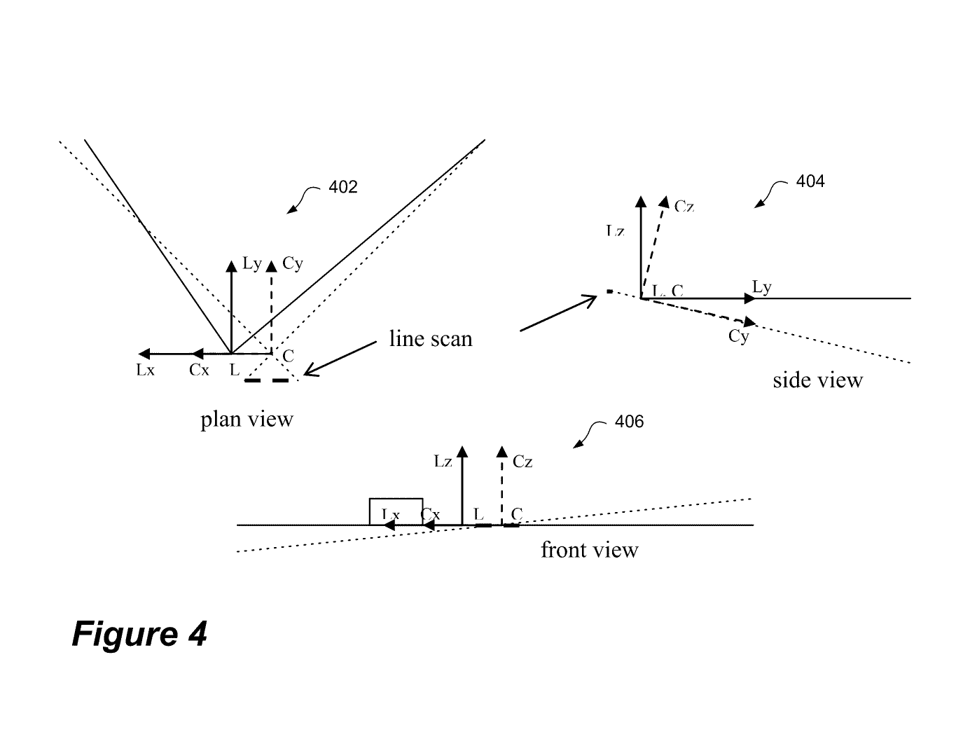

FIG. 4 shows a geometric representation of the relationship between the line scan camera body coordinate reference frame and the LiDAR coordinate reference frame. Two local Cartesian body frames are defined: the laser body frame, and the line scan camera body frame. The laser body frame origin is at the laser's center of scanning L with the Y-axis Ly pointing straight forward in the direction of a zero scan angle (plan view 402). The Z-axis Lz is perpendicular to the scanning plane and the X-axis Lx is perpendicular to the other two (front view 404). The line scan camera body frame has it's origin at the camera's perspective center C, the Y-axis coincident with camera's optical axis Cy. The Z-axis Cz is perpendicular to the scanning plane (side view 404) and the X-axis Cx completes the Cartesian axis triplet.

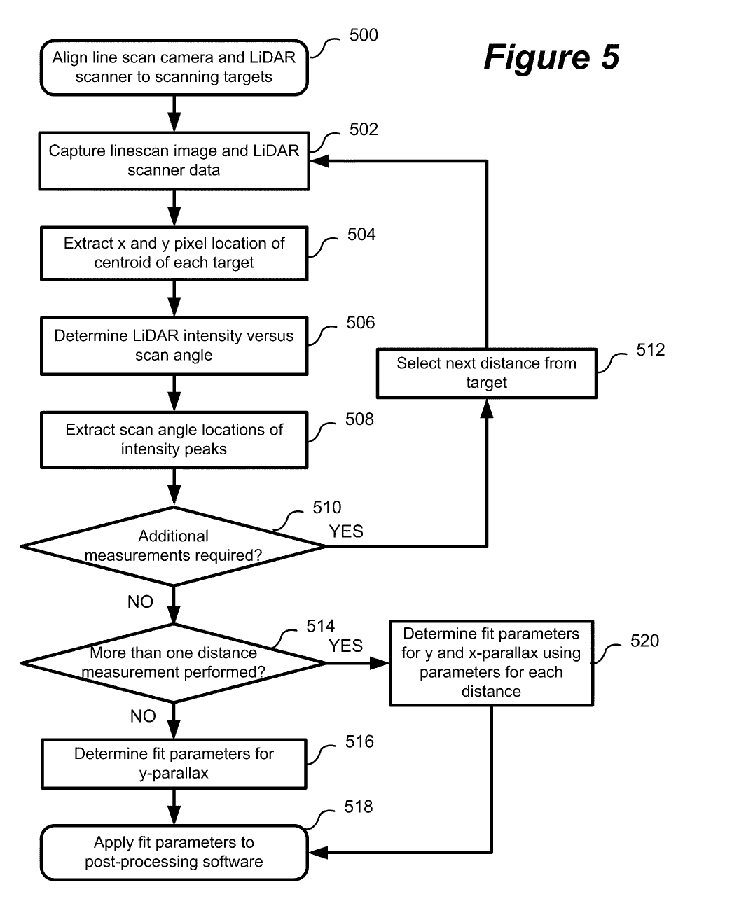

FIG. 5 shows a method of determining correction parameters. In mounting the cameras they are positioned to be in the laser scanning plane and as close as possible to the LiDAR coordinate reference center so as to eliminate the distance dependent up (z) parallax between the two sensors, leaving only a side (x) parallax to be removed by software. The camera's relative exterior orientation with respect to the LiDAR is rectified and then fixed using an adjustable mounting bracket with four degrees of freedom permitting all three rotations around the camera body coordinate axis as well as a linear translation along the z axis. Exterior orientation parameters of the camera with respect to the LiDAR are three linear offsets (X,Y,Z) and three rotations (Omega, Phi, Kappa). Ideally, rotation parameters to the LiDAR should be made the same for both LiDAR and camera.

The alignment of the camera's can be performed at 500 using the computing device 132 and the visual representation 141 to line up of imagery and laser scanner to be close to co-registered at given object distance (calibration distance). Once a coarse alignment has been performed the line scan image and LiDAR scanner data is captured simultaneously on the targets at 502. The x and y pixel location of centroid of each target from above image is extracted at 504 by using image target recognition within the capture line scan camera frame. Scan angle locations of intensity peaks which correspond to individual targets are extracted at 506 from the capture line scan camera image and LiDAR data. This can be represented, as shown in FIG. 7, as a plot of the LiDAR return intensity 610 versus the scan angel 620 to produce a plot 600. Scan angle location of intensity peaks are located to which correspond to individual targets are extracted at 508. If the calibration to be performed at more than one distance from the target surface addition measurements are to be performed, YES at 510, then the next distance is selected 512 and the measurements are performed again at 502. If only one distance measurement has been performed, NO at 510 and NO at 514, then a least squares adjustment is performed at 516 to determine row and column (pixel location) of laser return versus scan angle using only one set of collected data points. If data for multiple distances have been collected, YES at 514, the least square adjustment is performed for multiple axes at 520. The polynomial order of the model depends on the number of distance observed. For example, for three distances the fit would be a linear model, for four distances, a second order polynomial can be utilized.

The least square adjustment is determined by:

X_{image}=A*θ³+B*θ²+C*θ+D

Y_{image}=F*θ²+G*θ+H

whereθ=LaserScan

where the parameters A, B, C, D, F, G, and H are solved for in a least squares adjustment to minimize the residuals in the X and Y pixel fit.

Note that if required, the order of the polynomial fit in each coordinate can be increased or decreased if additional parameters are required to properly fit the observations. In practice however, a third order fit along track and second order fit across track gives sub pixel residual errors.

The fit or parallax correction parameters, along with some other camera specific parameters are then fed into the post processing software at 518. The determined parallax correction parameters are applied by post processing software at 518 to collected line scan camera images and LiDAR point cloud data to ensure accurate fusing of RGB color data. It should be noted that although and RGB line scan camera is discussed, the procedure is applicable to a wide range of passive sensors or various wavelengths including but not limited to hyperspectral and infrared capable cameras.

During calibration, each recorded laser measurement is returned from the laser scanner with a precise time tag which can be converted into a range and scan angle from the laser origin. The raw scan angle is used to compute the nominal distance parallax correction as noted below. A determined pixel location in the linescan image is captured at the same time as the laser measurement, but only at the nominal (middle calibration) distance. The range measurement is used (along with the scan angle) to compute an across scan correction factor based on the linescan image that In real-time each recorded laser measurement is returned from the laser scanner with a precise time tag, and can be converted into a range and scan angle from the laser origin. The raw scan angle is used to compute the nominal distance parallax correction detailed. At this point a pixel location can be determined from a linescan image captured at the same time as the laser measurement, but only at the nominal (middle calibrated) distance. Then, the range measurement is used (along with the scan angle) to compute an across scan correction factor based on range to target, from the model developed. At this point, a unique pixel location (x,y) in the linescan image that has been corrected for both x and y lens distortion/parallax, and has also been corrected for offset due to range to target. This pixel location represents the best modeled fit of the linescan image to the return LiDAR point measurement. The values correction parameters below are samples of the initialization values fed to the software which does the real-time colorization.
* 3rd Order Polynomial Fit Along Long Axis of LineScan (x=scan angle of laser) 0.000345807 // A*x*x*x
−-0.00024120554 // B*x*x
12.761567 // C*x
638.29799 // D
Second Order Polynomial Fit Across Short Access of Linescan (x=scan angle of laser)
0.0013899622 // A*x*x
−0.044159608 // B*x
6.83755 // C
Camera Specific Parameters
// Number of Pixels per Scanline
// Number of Scanlines Collected
// Size of Pixel on Chip in micrometers
4.69978 // Approximate Focal Length of Camera in millimeters
// Nadir Range at Calibration/Alignment
// Base Distance (Camera Origin to Laser Origin)
II Base Distance (Camera Origin to Laser Origin)—Vertical
1 // Laser Number

It will be apparent to one skilled in the art that numerous modifications and departures from the specific embodiments described herein may be made without departing from the spirit and scope of the present invention, an example being using many cameras to cover the field of view of a laser scanner with a large (i.e. >80 degree) field of view.

1. A method for aligning a line scan camera with a Light Detection and Ranging (LiDAR) scanner for real-time data fusion in three dimensions, the line scan camera and LiDAR scanner coupled to a computer processor for processing received data, the method comprising:
a) capturing imaging data at the computer processor simultaneously from the line scan camera and the laser scanner from target object providing a plurality of scanning targets defined in an imaging plane perpendicular to focal axes of the line scan camera and the LiDAR scanner, wherein the plurality of scanning targets spaced horizontally along the imaging plane;
b) extracting x-axis and y-axis pixel locations of a centroid of each of the plurality of targets from captured imaging data;
c) determining LiDAR return intensity versus scan angle;
d) extracting scan angle locations of intensity peaks which correspond to individual targets from the plurality of targets; and
e) determining two axis parallax correction parameters, at a first nominal distance from the target object, by applying a least squares adjustment to determine row and column pixel locations of laser return versus scan angle wherein the determined correction parameters are provided to post processing software to correct for alignment differences between the imaging camera and LiDAR scanner for real-time colorization for acquired LiDAR data.

2. The method of claim 1 wherein applying the least squares adjustment is defined by:
X_{image}=A*θ³+B*θ²+C*θ+D
Y_{image}=F*θ²+G*θ+H
whereθ=LaserScanAngle
wherein the parameters A, B, C, D, F, G, and H are solved for in a least squares adjustment to minimize the residuals in the X and Y pixel fit.

3. The method of claim 1 further comprising aligning the line scan camera and the laser scanner to be close to co-registered at the given target object distance.

4. The method of claim 2 wherein the order of the polynomial fit in each coordinate can be increased or decreased if additional parameters are required to properly fit the observations.

5. The method of claim 4 wherein the imaging correction parameters comprise:
number of pixels per scanline, number of scanlines collected, size of pixel on chip in micrometers, approximate focal length of camera in millimetres, nadir range at calibration/alignment, base distance for camera origin to laser origin, and base distance camera origin to laser origin vertical.

6. The method of claim 2 wherein a third order fit along track and a second order fit across track provides sub pixel resolution.

7. The method of claim 1 wherein the line scan camera is mounted at a location in the LiDAR scanner plane and as close as possible to the LiDAR coordinate reference center so as to eliminate the distance dependent up (z-axis) parallax between the two sensors, leaving only a side (x-axis) parallax to be removed by post processing software.

8. The method of claim 7 wherein the region of interest is located near the center of the line scan camera imager.

9. The method of claim 7 where in the aligning of the line scan camera and the LiDAR scanner is performed such that the region of interest surrounds the plurality of scanning targets.

10. The method of claim 1 wherein a polynomial fit of an across scan parallax due to differing target distances is determined whereby a) to d) are performed for more than one target distances from the line scan camera and the LiDAR scanner, and wherein in e), a polynomial fit is chosen based upon the number of distances observed and the best fit polynomial for those distance observed.

11. The method of claim 10 wherein the polynomial order for three distances is a linear model and the polynomial order for 4 distances is a second order polynomial.

12. A system for providing real time data fusion in three dimensions of Light Detection and Ranging (LiDAR) data, the system comprising:
a Light Detection and Ranging (LiDAR) scanner;
a line scan camera providing a region of interest (ROI) extending horizontally across the imager of the line scan camera, the line scan camera and the LiDAR scanner aligned to be close to co-registered at given target object distance defined in an imaging plane perpendicular to focal axes of the line scan camera and the LiDAR scanner, the target object providing a plurality of scanning targets spaced horizontally along the imaging plane;
a computer processor coupled to the LiDAR scanner and the line scan camera for receiving and processing data;
a memory coupled to the computer processor, the memory providing instructions for execution by the computer processor, the instructions comprising:
capturing imaging data simultaneously from line scan camera and laser scanner from the plurality of targets at the computer processor;
extracting x and y pixel locations of a centroid of each of the plurality of targets from captured imaging data;
determining LiDAR return intensity versus scan angle;
extracting scan angle locations of intensity peaks which correspond to individual targets from the plurality of targets;
determining correction parameters by applying a least squares adjustment to determine row and column (pixel location) of laser return versus scan angle;
wherein the determined correction parameters are provided to a post processing software to correct for alignment differences between the imaging camera and LiDAR scanner for real-time colorization for acquired LiDAR data.

13. The system of claim 12 further comprising a plurality of line scan cameras, each camera covering a portion of field of view of the LiDAR scanner.

14. The system of claim 13 wherein the LiDAR scanner provides a field of view of 360° for and the plurality of line scan cameras comprises at least 4 cameras.

15. The system of claim 12 wherein applying the least squares adjustment is defined by:
X_{image}=A*θ³+B*θ²+C*θ+D
Y_{image}=F*θ²+g*θ+H
whereθ=LaserScanAngle
wherein the parameters A, B, C, D, F, G, and H are solved for in a least squares adjustment to minimize the residuals in the X and Y pixel fit.

16. The system of claim 15 wherein the order of the polynomial fit in each coordinate can be increased or decreased if additional parameters are required to properly fit the observations.

17. The system of claim 12 wherein the imaging correction parameters comprise:
number of pixels per scanline, number of scanlines collected, size of pixel on chip in micrometers, approximate focal length of camera in millimetres, nadir range at calibration/alignment, base distance for camera origin to laser origin, and base distance camera origin to laser origin vertical.

18. The system of claim 12 wherein a third order fit along track and a second order fit across track provides sub pixel resolution.

19. The system of claim 12 wherein the line scan camera is mounted at a location in the LiDAR scanner plane and as close as possible to the LiDAR coordinate reference center so as to eliminate the distance dependent up (z) parallax between the two sensors, leaving only a side (x) parallax to be removed by software.

20. The system of claim 19 where in the alignment of the line scan camera and the LiDAR scanner is performed such that the region of interest surrounds the plurality of scanning targets.
